(19) United States
(12) Patent Application Publication
(10) Pub. No.: US 2015/0220687 A1
(43) Pub. Date: Aug. 6, 2015

(54) SYSTEM FOR SEARCHING FOR DRUG THAT MINIMIZES INDIVIDUAL SIDE EFFECT BASED ON INDIVIDUAL SINGLE NUCLEOTIDE POLYMORPHISM, AND METHOD THEREOF

(71) Applicant: Hyeong Jun AN, Frankfurt (KR)

(72) Inventor: Hyeong Jun An, Frankfurt (DE)

(21) Appl. No.: 14/410,737

(22) PCT Filed: Oct. 8, 2013
(86) PCT No.: PCT/KR2013/008998

§ 371 Date: Dec. 23, 2014

(30) Foreign Application Priority Data
Oct. 16, 2012 (KR) 10-2012-0114908

(51) Int. Cl. G06F 19/00; G06F 17/30

(52) U.S. Cl. CPC G06F 19/326; G06F 17/3053; G06F 17/30554

(57) ABSTRACT

A system and a method for searching for a drug that minimizes an individual-specific side effect based on an individual single nucleotide polymorphism. The method and the system include the processes of: constructing an individual-specific drug side effect DB including individual SNP information extracted from individual nucleotide sequence information; searching for the same kind of drugs and ingredients thereof having the same expected result by inputting a product name or ingredient name of a drug to search for whenever the drug is prescribed or purchased; searching for whether a side effect exists and a probability of the side effect by retrieving the searched ingredients from the individual-specific drug side effect DB; and outputting the result in order of the drugs having the lowest risk of causing side-effects. Therefore, it enables a doctor or a pharmacist to write a prescription configured to have the lowest risk of causing side effects.

### TECHNICAL FIELD

The present invention relates, in general, to a system and method for minimizing the likelihood that a patient will experience a drug side effect and, more particularly, to a system and method for searching for a drug, which minimizes an individual-specific side effect based on an individual single nucleotide polymorphism, which searches for and provides a drug having little possibility of side effects among drugs that a patient with a given individual nucleotide sequence intends to purchase, or a doctor of the patient intends to prescribe, based on the patient's nucleotide sequence.

### BACKGROUND ART

According to advances in medical science, an average life span of people is longer than in the past. As the elderly population increases, physical ability is degraded, and people suffer from a variety of diseases.

In a general hospital or a clinic, a doctor issues a medicine prescription after treating a patient. The medicine prescription is written by a doctor or a pharmacist based on the professional knowledge and experience.

The prescription written by a doctor or a pharmacist may include two or more medicines, and ingredients of the respective medicines may cause a cross-reaction.

Accordingly, when a doctor delivers a medicine prescription and directions based on a result of treatment to a pharmacist, the pharmacist, being well-informed of the prescription and directions, fills the prescription and provides the medicine to a patient. Also, the pharmacist should deliver directions for taking the medicine at the time of providing the medicine to the patient.

In other words, in the procedure of prescribing a drug, it is important for a doctor to prescribe the drugs that have been reported as having few side-effects in the academic world, so as to avoid side-effects.

A technique about a medicine prescription system for the prevention of a misprescription has been disclosed in Korean Patent Application No. 2002-90775.

FIG. 1 is a diagram to describe how to prescribe a drug by a doctor based on the doctor's experience. As shown in FIG. 1, for a specific symptom or disease, the doctor considers all drugs to prescribe (S11), and selects and prescribes a drug expected to have the least side-effects according to the doctor's experience and recently reported clinical results (S12). Then, the doctor observes whether the symptom is improved.

The symptoms may be improved without a serious side effect, but, when improvement of the symptom is not experienced, and/or serious side-effects are (S13), the step of examining and prescribing the other drugs excluding the drug that has been prescribed, is repeated.

Although a drug has only a low probability of causing a given side-effect, the patients who were prescribed the drug may have a higher probability of developing the side effect; additionally even though a drug is reported as being quite probable to cause side effects, it may be the best drug to in terms of relieving symptoms for a certain patient.

Accordingly, searching for patient-specific drugs is a current medical innovation being explored.

Like this, the reason why a drug reaction varies from individual to individual comes from 0.1˜0.2% differences in the human DNA. It is also the reason for the difference in appearance by a racial group or regional group. This phenomenon is called SNP: Single Nucleotide Polymorphism.

In other words, SNP (Single Nucleotide Polymorphism) refers to one or several numbers of nucleotide sequence variations which make individuals different from one another, among the 3 billion nucleotide sequences that a given chromosome within a cell nucleus has. Whether a person will develop a disease and a variation in phenotype come from 0.1% of differences in SNP.

When a draft of human nucleotide sequences was first announced in 2000, an analysis for a nucleotide sequence was only available as a national plan requiring a lot of manpower and cost; therefore, it was impossible to analyze a nucleotide sequence for each individual.

However, thanks to rapid technological progress, a personal genome sequence analysis is now commercialized, and it is available at an affordable price (whole genome sequencing costs below $5,000 by Knome, Inc. in 2012)

With increase in the quantity of SNP, studies on the side effects of drugs and disease-related studies are actively progressed. Because the results of the studies are being registered in the SNP database such as dbSNP, SNPedia, pharmgkb, after a personal genome sequence analysis, it is easy to know using the database whether a person will experience a given side effect or to which disease, drugs, chemicals, or vaccines the person is vulnerable.

FIG. 2 is a flow diagram for processes to analyze a personal nucleotide sequence. When a nucleotide sequence analysis is requested by delivering body tissues sample from which a personal DNA may be extracted, to personal genomics companies, the nucleotide sequence analysis is performed (S21).

The company analyzes and identifies the nucleotide sequence consisting of A (Adenine), G (Guanine), C (Cytosine), and T (Thymine) (S22).

Generally, an association with a genetic disease like a cancer is examined using the nucleotide sequence, and a corresponding report is generated (S23).

The report is used as reference data to be applied to a treatment when a doctor prescribes a given treatment of disease or seeks an improvement of symptoms (S24).

However, because the report about a personal nucleotide sequence analysis is reported according to SNPs, not according to drugs, or because it only reports a probability of developing a specific disease, when a doctor intends to use the report for prescribing, it is necessary to search for all the information related to the given drug; and to decide which drug to prescribe by comparing the aforementioned information.

Accordingly, a system which searches for a drug according to a given side effect based on the nucleotide sequence information is necessary to effectively use the nucleotide sequence information when a doctor attempts to prescribe a drug appropriate for a patient.

Also, although a patient takes a non-prescription medicine, a slight side effect may occur. Additionally, purchasing a drug without a doctor's advice may always have an inherent risk. Consequently, people who have no medical knowledge need to effectively research which drug might be best for them.

### DISCLOSURE

### Technical Problem

Accordingly, the present invention has been made keeping in mind the above problems occurring in the prior art, and an object of the present invention is to provide a system and method for searching for a drug that minimizes an individual's probability of experiencing side effects based on an individual single nucleotide polymorphism, which enables one to search for a drug having a low probability of producing individual-specific side effects, among drugs having the same expected effect in the anticipated deluge of genetic information.

Another object of the present invention is to provide a system and method for searching for a drug that minimizes an individual-specific side effect based on an individual single nucleotide polymorphism, which enables to purchase the drug after checking a side effect thereof although the drug is a non-prescription drug.

### Technical Solution

In order to accomplish the above objects, the present invention provides a system for searching for a drug that minimizes an individual-specific side effect based upon an individual single nucleotide polymorphism; having an individual-specific drug side effect DB configuration unit, which includes individual SNP (Single Nucleotide Polymorphism) information extracted from individual nucleotide sequence information, and a drug ingredient DB, which includes the same kind of drugs and ingredients thereof with the same expected effect; and which may be configured to include a search unit and a side-effect search unit. The search unit searches the drug ingredient DB using one or more pieces of information among: a product name of a drug, ingredient name, purpose of treatment, and drug manufacturer. The side-effect search unit searches for whether a side effect exists and a probability of the side effect by questioning the individual-specific drug side effect DB configuration unit about the information searched by the search unit and individual SNP information; and outputs the results in order of the drugs having the lowest risk of causing side effects.

Also, the system may further include a SNP DB that is configured to include one or more pieces of information among a disease, clinical information, or drug side effect information according to SNP ID. Additionally, it is desired that the individual-specific drug side effect DB configuration unit constructs a DB of drug side effects according to SNP by searching the SNP DB.

Also, the individual-specific drug side effect DB configuration unit is configured to include: a SNP input unit for inputting SNP ID and SNP nucleotide information; a SNP DB search unit for searching for whether a side effect exists by searching the SNP DB using the input SNP ID and SNP; and an individual-specific drug side effect DB for storing SNP information when it is determined by the search result that the SNP-related drug side effect exists.

Additionally, the side effect search unit is configured to include a DB interface unit for retrieving whether a SNP with possibility of side effect exists from the individual-specific drug side effect DB by receiving drug ingredient names with a same effect as an input, which are obtained from the expected effect and product names searched by the search unit; a side effect comparison unit for performing a comparison between the drugs according to the results retrieved by the DB interface unit; and an output unit for outputting the comparison result of the side effect comparison unit in order of drugs having the lowest risk of causing side effects. It is more desirable that the side effect comparison unit assigns a grade of risk according to the frequency and result of a side effect when the side effect is found as the search result of the DB interface unit.

On the other hand, a method for searching for a drug that minimizes an individual-specific side effect based on an individual single nucleotide polymorphism, having an individual-specific drug side effect DB, which includes individual SNP (Single Nucleotide Polymorphism) information extracted from individual nucleotide sequence information; and a drug ingredient DB, which includes the same kind of drugs with the same expected effect and ingredients thereof, according to an embodiment of the present invention, may be configured by the processes of: (a) constructing an individual-specific drug side effect DB and a drug ingredient DB; (b) searching the drug ingredient DB for same kind of drugs given as inputs; (c) retrieving the same kind of drugs searched in the step (b) from the individual-specific drug side effect DB; (d) searches for whether an SNP with a potential side effect exists from the retrieved result; and (e) if a SNP with a potential side effect is searched in the step (d), assigning the SNP a grade of risk based on the frequency and result of the side effect.

The individual-specific drug side effect DB is constructed by the processes of: (a-1) inputting SNP ID and SNP nucleotide information, which are a customer's SNP information, through an SNP input unit; (a-2) searching for whether drug side effect information exists by searching SNP DB in which one or more pieces of information among disease, clinical information, and drug side effect information is recorded, using the SNP ID and SNP input in the step (a-1); and (a-3) if the result of searching the SNP DB indicates that the SNP-related drug side effect information exists, storing the information about the SNP.

The individual-specific drug side effect DB is constructed to have one or more pieces of information among a drug ingredient name, SNP ID, SNP Allele, whether a side effect exists/frequency, and result of side effect. Also, the drug ingredient DB is constructed as a table inter-relating one or more information among a classification code, drug name, drug specification, daily dosage, number of medication, usage or manufacturer.

Also, it is configured to assign a grade of risk according to the frequency and result of a side effect if the side effect is found from the search results, and to output the result in order of the drugs having the lowest risk of causing side effects.

### Advantageous Effects

According to the system and method for searching for a drug that minimizes an individual-specific side effect based on an individual single nucleotide polymorphism by the present invention, it may search for and prescribe a drug having a minimum probability of side effects based on individual-specific genetic information.

Also, according to the system and method for searching for a drug that minimizes an individual-specific side effect based on an individual single nucleotide polymorphism by the present invention, when a doctor prescribes a drug or an individual purchases a drug without a prescription, it has an effect of protecting the individual from the risk of a side effect while increasing the curative influence of a drug.

Furthermore, according to the system and method for searching for a drug that minimizes an individual-specific side effect based on an individual single nucleotide polymorphism by the present invention, through a search and comparison method focusing on the drug, a doctor may reduce the time for deciding a drug to prescribe, and therefore, it contributes to a high quality of medical services.

### DESCRIPTION OF DRAWINGS

FIG. 1 is a flow diagram to illustrate a method for prescribing a drug by a doctor according to the doctor's experience in the prior art;

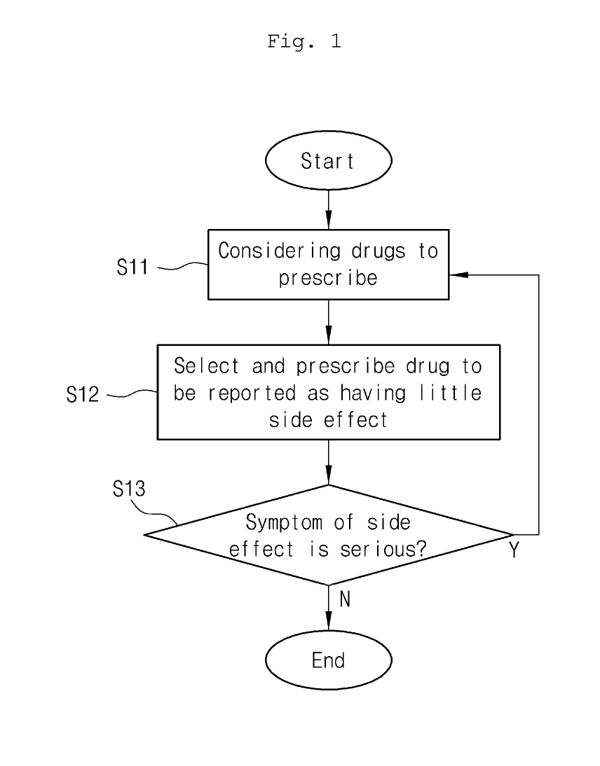

FIG. 2 is a flow diagram for processes of analyzing a personal nucleotide sequence in the prior art;

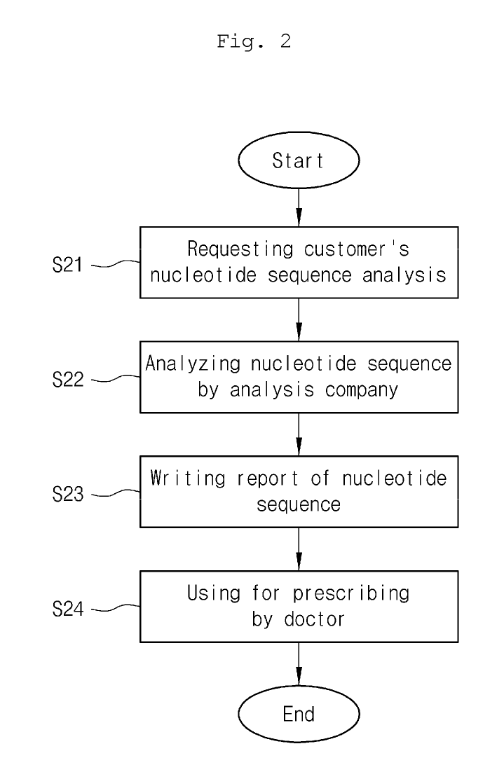

FIG. 3 is a diagram to illustrate a main configuration of a system for searching for a drug that minimizes an individual-specific side effect based on an individual single nucleotide polymorphism by the present invention;

FIG. 4 is a diagram to illustrate a process for constructing an individual-specific drug side effect DB by the present invention; and

FIG. 5 is a flow diagram to illustrate a step of prescribing based on a side effect by the present invention.

### BEST MODE

The terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention.

In the specification, when the explanatory phrase a part “includes” a component is used, this means that the part may further include the component without excluding other components, so long as special explanation is not given. Furthermore, terms such as “ . . . unit”, “ . . . machine”, “module”, “device”, etc., used in the specification refer to basic elements that can perform at least one function or operation. This can be embodied by combining hardware or software or combining hardware and software.

Hereinafter, an embodiment according to the present invention will be described with reference to accompanying drawings.

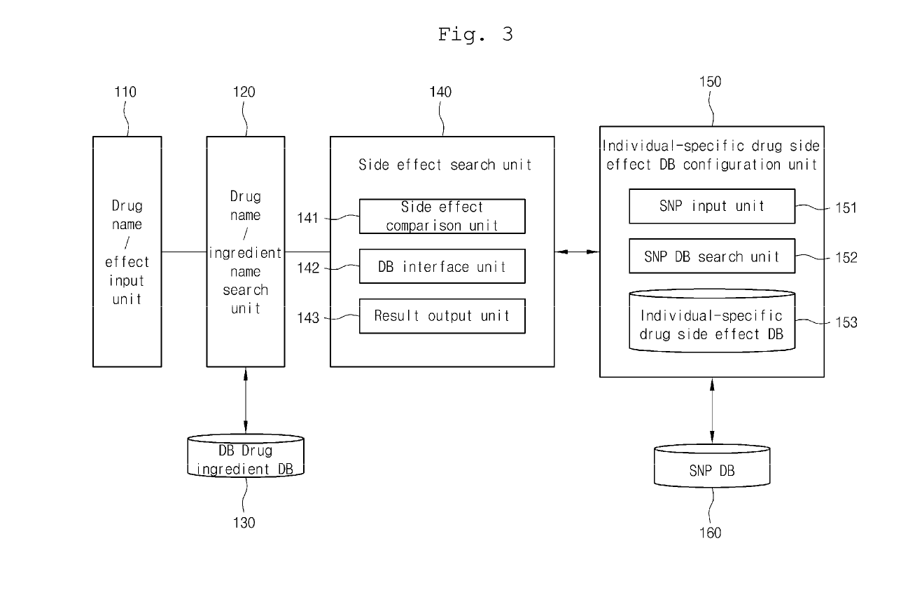

FIG. 3 is a diagram to illustrate a main configuration of a system for searching for a drug that minimizes an individual-specific side effect based on an individual single nucleotide polymorphism. As shown in FIG. 3, a system for searching for a drug may include an input unit 110 for inputting a product name or an ingredient name of a drug to query; a search unit 120 for searching a drug ingredient DB 130 for the drug name or ingredient name input from the input unit 110; and a side effect search unit 140 for searching for and providing a drug having low probability of individual-specific side effect by searching an individual-specific drug side effect DB 153 for the result from the search unit 120, the individual-specific drug side effect DB 153 being built by an individual-specific drug side effect DB configuration unit 150.

In other words, the present invention may achieve the object through the processes of: constructing an individual-specific drug side effect DB configuration unit 150 including individual SNP information extracted from an individual nucleotide sequence; searching for the same kind of drugs and ingredients thereof having the same expected effect in the search unit 120 by inputting a product name or ingredient name of a drug to prescribe or purchase whenever the drug is purchased and prescribed; searching for whether a side effect exists and a degree of the side effect by querying the respective searched ingredients to the individual-specific drug side effect DB configuration unit 150; outputting the results in order of the drugs having the lowest risk of causing side-effects.

The input unit 110 is configured with input devices including a common keyboard or mouse to enable to input a product name or ingredient name of a drug to search for when the drug is prescribed or purchased.

The drug ingredient DB 130 is a database constructed for searching for the same kind of drugs and ingredients having the same desired effect according to a product name or ingredient name of a drug.

For search convenience and efficiency in development of DB, the drug ingredient DB 130 is configured to have stored a table like Table 1 at the time of construction of DB, which interrelates information including a code for classifying drugs, a drug name, specification, daily dosage, the number of medication, ingredients, usage, or manufacturer, etc., with each other to be searched using the inter-relation between the drug-related information.

TABLE 1

| | | | | | | | |
|---|---|---|---|---|---|---|---|
| | Drug | Specifi- | Daily | No. of | | | Manufac- |
| Code | name | cation | Dosage | medication | Ingredient | usage | turer |

| | | | | | | |
|---|---|---|---|---|---|---|
| A00304031 | Dobutamine | 5 ml/A | 250 mg/c | 1 | Amoxixillinn | Adults: take |
| | HCl | | | | | 2 tablets at |
| | | | | | | once, 3-4 times |
| | | | | | | per day, put |
| | | | | | | into an empty |
| | | | | | | stomach |
| B04900026 | Duosol | 30 ml/A | 100 mg/c | 2 | Cefixim | stomach ulcer, |
| | Tab. | | | | | reflux |
| | | | | | | esophagitis, |
| | | | | | | take 1 tablet |
| | | | | | | daily before |
| | | | | | | bedtime |

The drug ingredient DB like Table 1 is one example, and it is possible to group the same kind of drugs, to make a table for drugs with the same ingredients, or to manage the drugs classified with the purpose of treatment.

For example, a database may be built as a table like Table 2, which classifies drugs with a product name and ingredient name of a drug according to the purpose of treatment.

TABLE 2

| purpose | Drug name | Ingredient name |
|---|---|---|
| Breast cancer | Cytoxan | Cyclophosphamide |
| chemotherapy | Nolvadex | Tamoxifen |
| | Taxotere | Docetaxel |

The search unit 120 is operated to search the drug ingredient DB 130 according to a drug name or an ingredient name, which are input from an input unit 110.

In other words, the search unit 120 is operated to extract the same kind of drugs and the ingredients thereof having the same desired effect by searching the drug ingredient DB 130 according to a drug name or ingredient name, which is input from an input unit 110, and to output the results to the side effect search unit 140.

The ingredients of a drug may be searched for using a public or commercial drug-related DB such as Rote Liste of Germany. As described above, for example, when a keyword like “chemotherapy of breast cancer” is input through the input unit 110 to search a product name with a desired effect of the treatment of breast cancer, a search unit 120 may search for and output the drugs like Cyclophosphamide, Tamoxifen, and Docetaxel, which are used for the treatment, through the drug ingredient DB 130.

Also, if Cytoxan, a product name of a pharmaceutical company, is only known, an ingredient name, Cyclophosphamide, may be searched for through the same method. Also, Tamoxifen, Docetaxel, which are the other ingredients having the same desired effect of chemotherapy of breast cancer, may be searched so as to enable a side-effect search unit 140 to compare the ingredients with each other.

The SNP DB 160 is a database such as dbSNP, SNPedia, Pharmgkb, in which according to SNP ID, disease, clinical information, drug side-effect information, etc. are stored as searchable data.

The individual-specific drug side effect DB configuration unit 150 is configured to search for drug side effect-related information according to individual SNP, depending on the DB of drug side effect according to SNP, which has been constructed.

In other words, given SNP ID and SNP nucleotide sequence information as input by a SNP input unit 151, a SNP DB search unit 152 is operated to search a SNP DB 160 using the SNP ID and SNP input by SNP unit 151, for whether a drug side effect exists; and to construct data related to an individual-specific drug side effect, the SNP DB 160 storing disease, clinical information, drug side effect information, etc. according to SNP ID, such as dbSNP, SNPedia, Pharmgkb, etc.,

Consequently, the individual-specific drug side effect DB configuration unit 150 is configured to include an input unit 151 that involves inputting a customer's SNP information; and a SNP DB search unit 152 that searches for information related to a drug side effect according to an individual SNP by retrieving the input individual SNP information from a public or commercial SNP DB 160.

The individual-specific side effect DB 153 is constructed using the side effect and degree of the side effect searched by the SNP DB search unit 152.

A way to access the SNP DB 160 may be various. If a DB only allows web searching, it may require a text mining within the text through WAN. Also, when a DB reveals DB data as a flat-file through a way of FTP (File Transfer Protocol), it is available to download the file and construct a private DB in a system using the file. Additionally, there are various ways including a DB gaining results in a predefined form when querying data by the protocol through WAN. However, because it is obvious to those skilled in this field, further explanation about the access methods will be omitted.

Also, a SNP DB 160 exists for various purposes in a various form, but mandatory data searched for to construct an individual-specific drug side effect DB 153 are exemplified in the Table 3.

Table 3 is an example of data to extract from the SNP DB 160 for constructing an individual-specific drug side effect DB 153, which includes SNP ID, SNP nucleotide, and whether a side effect of the drug exists and result of the side effect according to the SNP allele.

TABLE 3

| Drug | | | whether side | |
|---|---|---|---|---|
| Ingredient | | SNP | effect exist/ | Result of |
| name | SNP ID | Allele | frequency | side effect |
| Cyclophos- | Rs9561778 | G; G | Normal | |
| phamide | | T; T | 2X higher | |
| Tamoxifen | Rs6025 | A; A | Risk | thrombosis |
| | | G; G | Normal | |
| Docetaxel | Rs11045585 | A; A | 24% increased | leukopenia/ |
| | | | | neutropenia |
| | | A; G | 63% increased | leukopenia/ |
| | | | | neutropenia |

More specifically, in the Table 3, if a customer's SNP ID, which is input through a SNP input unit 151, is Rs9561778, and a SNP Allele is T;T, “whether side effect exist/frequency” field displays that the customer has two times more likelihood of the side effect for the drug, Cyclophosphamide, than a person having a common SNP.

As a result of searching SNP DB 160, if the information about the drug side effect related to a SNP is searched as the above example, the information corresponding to the SNP is only stored in the individual-specific drug side effect DB 153.

The side effect search unit 140 is configured to make the individual-specific drug side effect DB configuration unit 150 analyze and output whether the side effect of the drug exists according to the respective SNP based on the drugs extracted from the search unit 120.

Accordingly, the side effect search unit 140 is configured to include a DB interface unit 142 for retrieving the drug ingredient names with the same effect given as an input, which are obtained from the expected result or product name searched by the search unit 120, from the individual-specific drug side effect DB 153, which has been constructed; and a side effect comparison unit 141 for performing a comparison of the side effects according to the drugs depending on the retrieved results.

The DB interface unit 142 searches for whether SNP with potential side-effect exists by querying the same kind of drugs searched in a search unit 120 to an individual-specific drug side effect DB 153 of the individual-specific drug side effect DB configuration unit 150.

If a side effect is found as the result of searching in the DB interface unit 142, the side effect comparison unit 141 assigns a grade of risk considering the frequency of occurrence of the side effect, result of the side effect, and the like.

Also, if a side effect is not searched as the result of searching in the DB interface unit 142, a grade of risk may not be given in the side effect comparison.

Table 4 is a table to exemplify the result of the operation in the side effect comparison unit 141.

TABLE 4

| | | | Variance | |
|---|---|---|---|---|
| Drug | | SNP | of Risk of | Result of |
| ingredient | SNP ID | Allele | Side effect | side effect |
| Cyclophos- | Rs9651778 | T; T | 1 | |
| phamide | | | | |
| Docetaxel | 11045585 | A | 0.5 | leukopenia/ |
| | | | | neutropenia |
| Tamoxifen | Rs6025 | G; G | 0 | |

Referring to Table 4, three drug ingredients are searched through searching a drug ingredient DB 130 by a search unit 120, and the result of searching an individual-specific drug side effect DB 153 indicates that a side effect exists in the two drugs (Cyclophosphamide, Docetaxel) among the three ingredients.

For Tamoxifen, in which a side effect is not searched, 0 points are given for the risk of side effect, while for Cyclophosphamide, 1 point is given because it has SNP allele (T;T), which has two times more probability of the side effect like an example searching SNP DB 160 in Table 3. For Docetaxel, as it has SNP allele (A;A) with 24% of probability of the side effect, 0.5 points are given.

According to the result of the side effect, the risk of side effect may be changed.

For example, though Docetaxel has a lower value in the probability of occurrence of the side effect than Cyclophosphamide, if it is determined by considering a patient's state or other disease that leukopenia/neutropenia is serious due to decrease in leukocyte count, which affects immunity, a grade of the risk should be aggravated when the drug is prescribed.

Accordingly, through an output unit 143, the result may display which drug is optimized for the patient by comparing the relative risk of the side effect. Concretely, what side effect is caused by the drug is also displayed to give a help when a doctor finally makes a well-informed decision. The way to display the compared results may include a table written in the order that the operation rule has decided, or a graph.

Also, the display of the results, of course, may include all output methods through Web, Mobile Apps., document outputs in the hand-held devices that modern people carry, such as a smart phone, PDA, a personal computer, a server terminal, and the like.

A search method using a system for searching for drugs that that minimizes an individual-specific side effect based on the individual SNP polymorphism will be described.

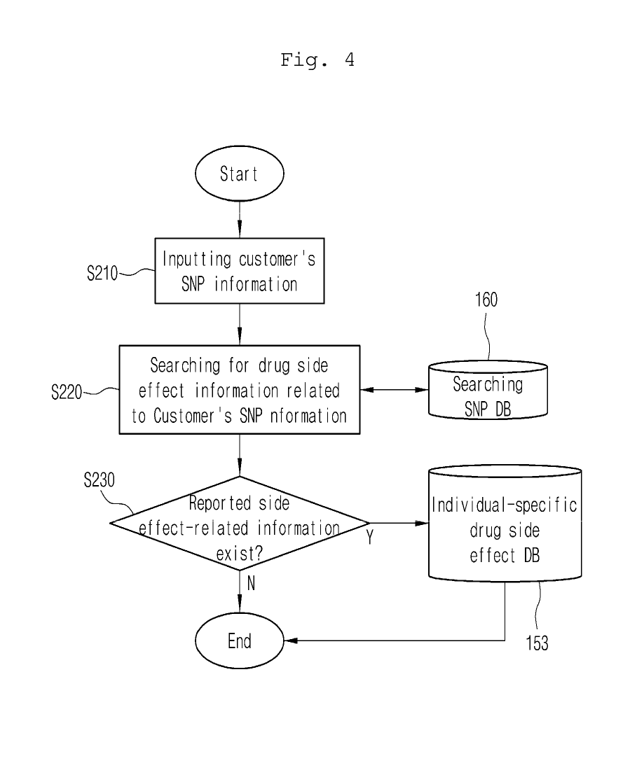

FIG. 4 is a flow diagram to illustrate a process for building an individual-specific drug side effect DB, and as shown in FIG. 4, a customer's SNP information, that is SNP ID and SNP nucleotide information, are input through SNP input unit 151 (S210), the customer's SNP information being obtained from the report delivered after individual nucleotide sequence analysis or through a computer program individually purchased.

Using the SNP ID and SNP input in the step S210, whether drug side effect information exists is searched for by searching SNP DB 160, which stores disease, clinical information, drug side effect according to SNP ID, such as dbSNP, SNPedia, Pharmgkb (S220).

As described above, a way to access DB may be various.

In the step of S230, it is determined whether the reported side effect information according to SNP exists in the information searched from the SNP DB 160.

In the step of S230, as the result of searching SNP DB 160, if drug side effect information related to a SNP exists, the information about the SNP is only stored in an individual-specific drug side effect DB 153.

FIG. 4 is an example in which a DB is constructed for a single SNP. However, it may be practically configured to routinely process a lot of SNPs at one time.

If the individual-specific drug side effect DB 153 is constructed through the process shown as FIG. 4, searching for a drug that minimize an individual-specific side effect based on individual SNP polymorphism is performed by the processes of: whenever a drug is prescribed or purchased, searching for the same kind of drugs and the ingredient thereof having the same desired effect by inputting a product name or ingredient name of a drug to search; retrieving the searched ingredients from an individual-specific drug side effect DB; searching for whether a side effect exists and degree of the side effect; and outputting the result in order of drugs having the lowest risk of causing side effects.

The process for prescribing like above will be described referring to the drawing.

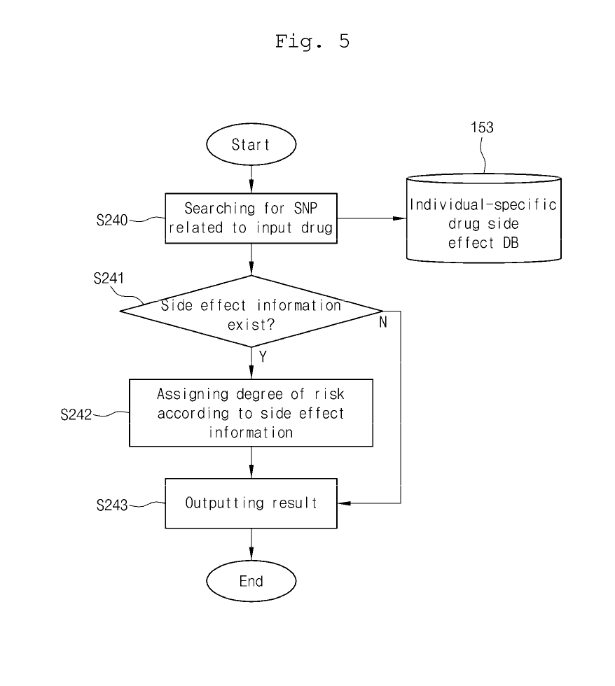

FIG. 5 is a flow diagram to illustrate a step of prescribing based on a side effect, and as shown in FIG. 5, a DB interface unit 142 searches for the same kind of drugs in the drug ingredient name search unit 120 (S240); and searches for whether the SNP with a possibility of the side effect exists by respectively retrieving the searched same kind of drugs from the individual-specific drug side effect DB 153 (S241).

If the SNP with a side effect is searched for in the step of S241, a side effect comparison unit 141 assigns a grade of risk by considering a frequency of occurrence of the side effect, a result of the side effect, and the like (S242).

If a side effect is not searched for in the step of S241, a grade may not be given in the risk comparison.

A result of the operation considering the degree of a risk and the side effect is exemplified in Table 4.

Referring to Table 4, three drug ingredients are searched through accessing a drug ingredient DB 130 by a search unit 120, and the result of searching an individual-specific drug side effect DB 153 indicates that a side effect exists in two drugs (Cyclophosphamide, Docetaxel) among the three ingredients.

For Tamoxifen, in which a side effect is not searched, 0 points are given for the risk of side effect, while for Cyclophosphamide, 1 point is given because it has SNP allele (T;T), which has two times more probability of the side effect as an example searching SNP DB 160 in Table 3. For Docetaxel, because it has SNP allele (A;A) with 24% of probability of the side effect, 0.5 points are given.

According to the result of the side effect, the risk of side effect may be changed.

For example, though Docetaxel has a lower value in the probability of occurrence of the side effect than Cyclophosphamide, if it is determined by considering a patient's state or other disease that leukopenia/neutropenia is serious due to decrease in leukocyte count, which affects immunity, a grade of the risk should be aggravated when the drug is prescribed.

Through an output unit 143, the result drawn from the step S242 may display which drug is optimized for the patient by comparing the relative risk of the side effect (S243).

Also, the detailed side effect is also displayed to give a help when a doctor finally makes a well-informed decision.

Also, the contents output from the result output unit 143 include display methods using a table written in the order that the operation rule has decided, or a graph. In addition, the display of the result, of course, may include all output methods through Web, Mobile Apps., document outputs in the hand-held devices that modern people carry, such as a smart phone, PDA, a personal computer, a server terminal, and the like.

As described above, the system and method for searching for a drug that minimizes an individual-specific side effect based on an individual single nucleotide polymorphism of the present invention is configured by the processes of: constructing an individual-specific drug side effect DB including individual SNP information extracted from an individual nucleotide sequence; searching for the same kind of drugs and ingredients having the same expected effect by inputting a product name or ingredient name of a drug to search for whenever a drug is purchased and prescribed; searching for whether a side effect exists and a degree of the side effect by querying the respective searched ingredients to the individual-specific drug side effect DB; and outputting the result in order of the drugs having the lowest risk of causing side-effects, and therefore, it enables a doctor or a pharmacist to write a well-informed prescription.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

A system and method for searching for a drug that minimizes an individual-specific side effect based on an individual single nucleotide polymorphism by the present invention relates to a technique to search and provide a drug to minimize an individual-specific side effect when attempting medication, based on an individual single nucleotide polymorphism.

1. A system for searching for a drug that minimizes an individual-specific side effect based on an individual single nucleotide polymorphism, having an individual-specific drug side effect DB configuration unit, which includes individual SNP (Single Nucleotide Polymorphism) information extracted from individual nucleotide sequence information, and a drug ingredient DB, which includes a same kind of drugs and ingredients thereof with a same desired effect, comprising:
a search unit for searching the drug ingredient DB using one or more pieces of information among a product name of a drug, an ingredient name, a purpose of treatment, a drug company; and
a side effect search unit for searching for whether a side effect exists and a degree of the side effect by questioning the individual-specific drug side effect DB configuration unit about the information searched by the search unit and individual SNP information, and for outputting the results in order of the drugs having the lowest risk of causing side effects.

2. The system of claim 1, further comprising
a SNP DB is configured to include one or more pieces of information among a disease, clinical information, or drug side effect information,
wherein the individual-specific drug side effect DB configuration unit creates an individual-specific drug side effect DB by searching the SNP DB.

3. The system of claim 2, wherein the individual-specific drug side effect DB configuration unit comprises:
a SNP input unit for inputting SNP ID and SNP nucleotide information;
a SNP DB search unit for searching for whether a drug side effect information exists by searching the SNP DB using the SNP ID and SNP, which have been input by the SNP input unit; and
an individual-specific drug side effect DB, if it is determined by the search result that a drug side effect information related to the SNP exists, for storing the information related to the SNP.

4. The system of claim 3, wherein the individual-specific drug side effect DB is built to include one or more pieces of information among a drug ingredient name, SNP ID, SNP Allele, whether a side effect exists/frequency, and a result of a side effect.

5. The system of claim 2, wherein the side effect search unit comprises:
a DB interface unit for retrieving whether a SNP with possibility of side effect exists from the individual-specific drug side effect DB by retrieving drug ingredient names with a same effect as an input, which are obtained from a desired effect or a product name searched by the search unit.
a side effect comparison unit for performing a comparison between drugs according to the search result of the DB interface unit; and
an output unit for outputting the comparison result from the side effect comparison unit in order of the drugs having the lowest risk of causing side effects.

6. The system of claim 5, wherein the side effect comparison unit is operated to assign a grade of risk according to a frequency of occurrence of a side effect and a result of the side effect when the side effect is found as the result of the search by the DB interface unit.

7. The system of claim 6, wherein the output unit outputs one or more pieces of information among a drug ingredient name, SNP ID, SNP Allele, a degree of risk of side effect, and a result of side effect if a side effect is found as the result of comparison by the side effect comparison unit.

8. A method for searching for a drug that minimizes an individual-specific side effect based on an individual single nucleotide polymorphism, having an individual-specific drug side effect DB, which includes individual SNP (Single Nucleotide Polymorphism) information extracted from individual nucleotide sequence information, and a drug ingredient DB, which includes a same kind of drugs and ingredients thereof with a same desired effect, comprising:
(a) constructing the individual-specific drug side effect DB and the drug ingredient DB;
(b) searching the drug ingredient DB for a same kind of drugs that have been input;
(c) retrieving the same kind of drugs, which have been searched in the step of (b), from the individual-specific drug side effect DB;
(d) searching for whether an SNP having possibility of a side effect exists as the result of retrieving; and
(e) assigning a grade of risk based on a frequency and result of a side effect when an SNP with the side effect is searched in step (d).

9. The method of claim 8, wherein the individual-specific drug side effect DB in the step of (a) comprises:
(a-1) inputting SNP ID and SNP nucleotide information, which are customer's SNP information, through a SNP input unit;
(a-2) searching SNP DB for whether drug side effect information exists using the SNP ID and SNP, which have been input in the step of (a-1), the SNP DB storing one or more pieces of information among a disease, clinical information, and drug side effect information according to SNP ID; and
(a-3) if drug side effect information related to an SNP exists as a result of searching SNP DB, storing and constructing the information related to the SNP.

10. The method of claim 9, wherein the step of (a-3) involves constructing an individual-specific drug side effect DB that includes one or more pieces of information among a drug ingredient name, SNP ID, SNP Allele, whether a side effect exists and frequency, and a result of the side effect.

11. The method of claim 8, wherein the drug ingredient DB in the step (a) is constructed as a table that interrelates one or more pieces of information among a classification code, drug name, specification, daily dosage, number of medication, usage, or a manufacturer.

12. The method of claim 8, wherein the step of (e) further comprises, if a side effect is found as a search result, assigning a grade of risk according to a frequency of occurrence of a side effect and result of the side effect.

13. The method of claim 12, wherein the step of (e) outputs one or more pieces of information among a drug ingredient name, SNP ID, SNP Allele, a degree of risk of a side effect, and a result of the side effect.
